(19) United States
(12) Patent Application Publication
(10) Pub. No.: US 2022/0260283 A1
(43) Pub. Date: Aug. 18, 2022

(54) Efficient Solar Powered Removal of Volatile Components from Slurries

(71) Applicant: D&D Manufacturing, LLC, Rockledge, FL (US)

(72) Inventor: Dale E. Polk, JR., Titusville, FL (US)

(21) Appl. No.: 17/174,413

(22) Filed: Feb. 12, 2021

(51) Int. Cl. F24S 10/70; E21B 43/24; E21B 43/243

(52) U.S. Cl. CPC F24S 10/70; E21B 43/243; E21B 43/2401

(57) ABSTRACT

A system and method for the removal of volatile components from a liquid or a slurry containing solids and liquids and using a screw conveyor or auger system that transfers solid/liquid slurries through an elongated tube heated by solar energy from a parabolic solar trough. The system flashes off the volatile component then counter-currently flows that vapor back into the hollow pipe inside of the augur creating a Multi-effect or Multi Flash device which greatly improves the overall efficiency of removal of the volatile material.

### FIELD

This disclosure relates to the removal of volatile components from a liquid or a slurry containing solids and liquids and using a screw conveyor or auger system that transfers solid/liquid slurries through a tube heated by solar energy from a parabolic solar trough. The system flashes off the volatile component then counter-currently flows that vapor back into the augur creating a Multi-effect or Multi Flash device which greatly improves the overall efficiency of removal of the volatile material.

### BACKGROUND

There are numerous industrial operations that introduce volatiles into their operations and then require that those volatiles be removed later. Well known applications are mines or quarries that introduce water and later require that the moisture be removed. Dewatering is a process that separates liquid-solid mixtures, such as slurries comprised of particles and process water, that are present in aggregate, minerals, coal and frac sand wet processing applications.

A number of chemical engineering unit operations have been developed in the past to deal with water removal. Wet classification is a process of separating particles in a feed material depending on their settling rates in a fluid. Larger, heavier sized particles sink to the bottom, while smaller, lighter fractions float to the top and overflow weirs on the equipment. Centrifugation can dewater materials by centrifugal force that draws particles away from the center of rotation. Filtration can remove water and other liquids from slurries by forcing the liquid through a permeable barrier or filter media and leave a trapped cake of drier solids that are too large to pass through the barrier or filter media. Dewatering through filtration creates dry material as well as reusable process water.

These approaches can be complex and in some cases labor intensive.

### BRIEF DESCRIPTION OF THE DRAWINGS

FIG. 1 illustrates an overall view of an embodiment of this disclosure utilizing an elongated tube mounted within a parabolic solar trough with a slurry fill on the left end and a waste drop on the other end of the elongated tube.

FIG. 2 illustrates some of the internals of the elongated tube of FIG. 1, including a mechanically powered augur within the elongated tube that conveys the slurry through the elongated tube where it is heated by solar impingement, volatilizing the liquid in the slurry as it is being conveyed from the slurry fill end to the waste drop end. The volatilized liquid passing through is returned via an internal hollow pipe back through the augur where it is released with all solids removed.

FIG. 3 is a more detailed view of the waste end of the elongated tube illustrating a long auger waste discharge from the system.

FIG. 4 is another view of the long augur waste discharge illustrating the internal auger.

### BRIEF SUMMARY

This disclosure describes a solar powered device for efficient removal of volatile liquids from industrial solid-liquid slurries including at least: a screw conveyor inside an elongated tube, with the conveying flights of the screw conveyor mounted onto a hollow pipe within the elongated tube; a first end of the elongated tube comprising a feed port for a solid-liquid slurry; a second end of the elongated tube comprising a waste drop for removal of the solids material after its liquids have been removed; wherein the elongated tube is centered in a parabolic solar trough that impinges solar energy onto the elongated tube to volatilize the volatile liquid from the contained slurry; wherein the elongated tube is not perfectly round but is topped with an enclosed vertical U-shaped or V-shaped top that provides a pathway for the volatile vapor removed from the solid-liquid slurry; and wherein the hollow pipe that recycles the volatile vapor removed from the solid-liquid slurry counter-currently back through the hollow pipe within the elongated tube removes the resulting liquid. Furthermore, the solids removed through the waste drop from the elongated tube pass through a long auger discharge where they are conveyed by an internal screw conveyor and finally exist the overall device through a final waste drop.

The disclosure also describes a method for utilizing solar power for efficient removal of volatile materials such as water from industrial slurries including at least: providing a screw conveyor or auger inside an elongated tube, with the conveying flights of the screw conveyor mounted onto a hollow pipe within the elongated tube; providing a first end of the elongated tube with a feed port for a solid-liquid slurry; providing a second end of the elongated tube with a waste end for removal of solids material; positioning the elongated tube in a parabolic solar trough that impinges solar energy onto the elongated tube to volatilize the volatile liquid from the contained slurry; providing an enclosed vertical U shaped top to the elongated tube that provides a pathway for the volatile vapor removed from the solid-liquid slurry; providing a vacuum at the first end of the elongated tube to drive the flow of volatized vapor in a counter-current flow in the hollow pipe of the elongated tube; providing an exit from the hollow pipe of the elongated tube for removing the liquid of the solid-liquid slurry. Furthermore the method provides for feeding the solids from the waste drop from the elongated tube pass through a long auger discharge where they are conveyed by an internal screw conveyor and finally exist the overall device through a final waste drop.

### DETAILED DESCRIPTION

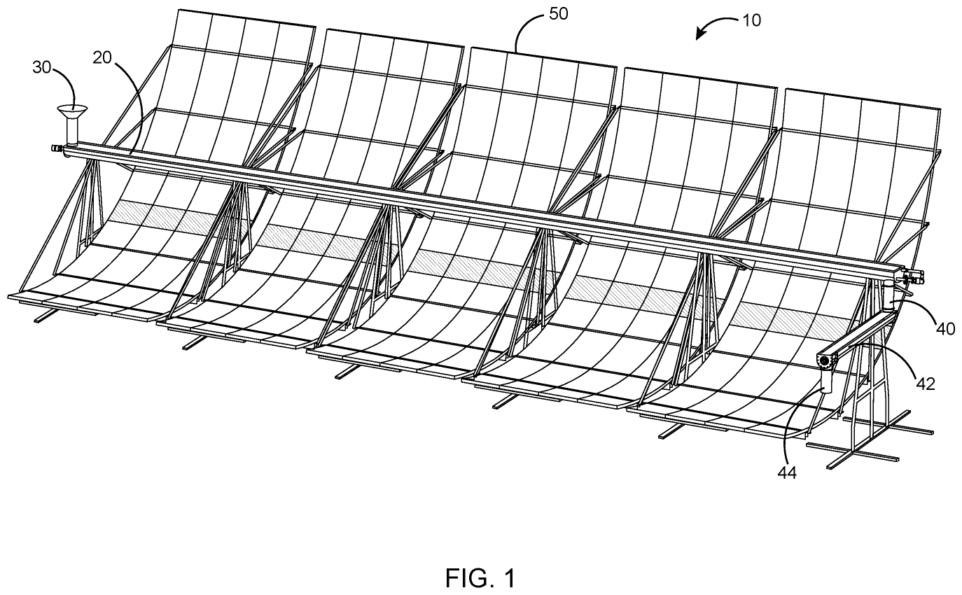

Referring now to FIG. 1 and shown generally as numeral 10 is an elongated tube 20 mounted within a parabolic solar trough 50 with a slurry fill 30 on a first end and a waste drop 40 on a second end of the elongated tube. In a given installation in a particular application there could be one such elongated tube and for larger applications there could be multiple of these tubes aligned within multiple solar troughs. In use a solid-liquid slurry containing a volatile material is fed on the left end of elongated tube 20 through slurry fill opening 30 and travels down the elongated tube 20 and is heated by solar impingement from the parabolic solar trough 50. The waste drop 40 feeds into a long auger discharge 42 and eventually discharges from the system at waste drop 44. The long auger discharge is described in following Figures.

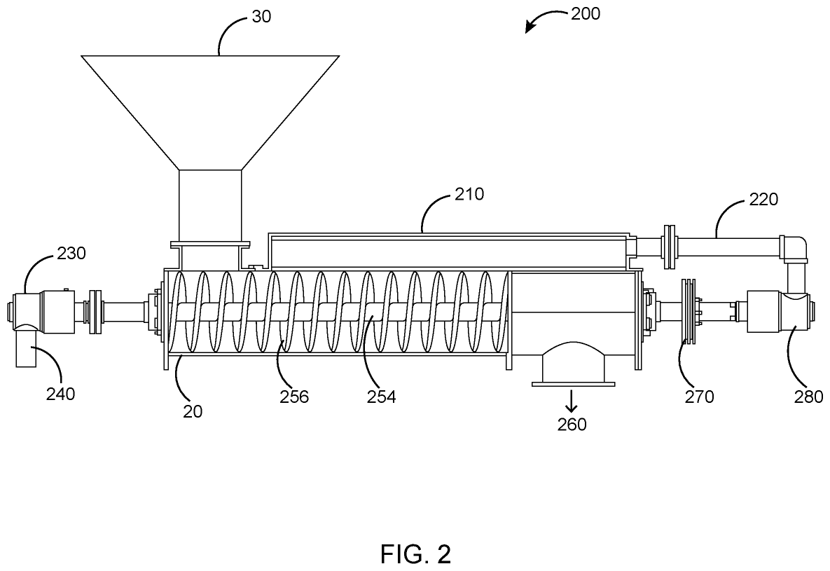

FIG. 2, shown generally as numeral 200 is now focused on the internal and external aspects of the elongated tube shown as 20 in FIG. 1. The elongated tube is hollow and can be of elongated length but is shown in a compressed form in FIG. 2 for illustration purposes. The slurry fill 30 is shown at a first end of the hollow elongated tube and comprises a screw conveyor (augur) 256 within the elongated tube that serves to convey the slurry down the hollow elongated tube 20 toward a waste discharge 260 at the other end. The waste discharge 260 feeds into the waste drop 40 of FIG. 1.

As the slurry is being conveyed the hollow elongated tube 20 is heated by solar impingement from the parabolic solar trough, volatilizing the liquid in the slurry as it is being conveyed from the slurry fill end to the waste discharge end. The elongated tube 20 is not completely round in that it has an enclosed vertical U-shaped or V-shaped “hen house” top 210 along the top. As the liquid is being volatilized from the slurry while traveling down the elongated tube 20 the volatile liquid (steam in the case of water) it is collected overhead in the “Hen House” or vertical structure 210 on top. This vapor is redirected back counter-currently via pipe 220 and is returned through a hollow pipe 254 that is internal to the screw conveyor or auger 256, thus releasing its heat of vaporization as it condenses back within the hollow pipe 254 via heat conduction, creating a multi-effect/multi-flash system before the resulting removed volatile liquid is removed from the system at the far end through pipe 240.

A vacuum (not shown) is applied at the first end 230 of the system to give the volatile vapor a flow direction and to lower the boiling point of the liquid. Although not shown in the figures, maintenance of the vacuum is aided by a controller that controls the level of slurry in the slurry fill 30 as the system runs.

The conveying flights of the screw conveyor 256 are mounted on the hollow pipe 254 that also serves to pass recycled volatiles back toward the slurry feed entrance in a counter-current flow to exchange heat via heat conduction through hollow pipe 254 with the entering slurry.

As shown previously in FIG. 1 the entire apparatus described above is centered in a parabolic trough which is heated through solar impingement and multiple elongated tubes could be centered in multiple parabolic troughs of varying lengths dependent on the application.

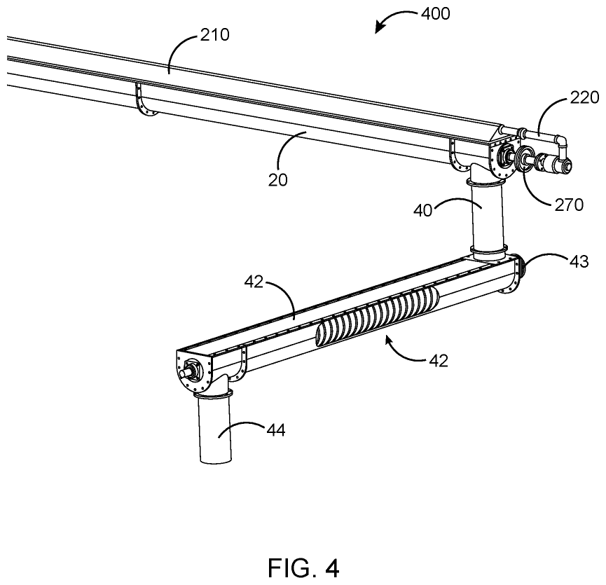

The process is controlled by the screw conveyor speed. So that, if one wants to dry the material more, the screw conveyor speed is less, or if the desire is to remove less liquids, the screw speed is increased. The screw conveyor speed is controlled by a chain driven sprocket wheel 270 (FIGS. 2 and 4).

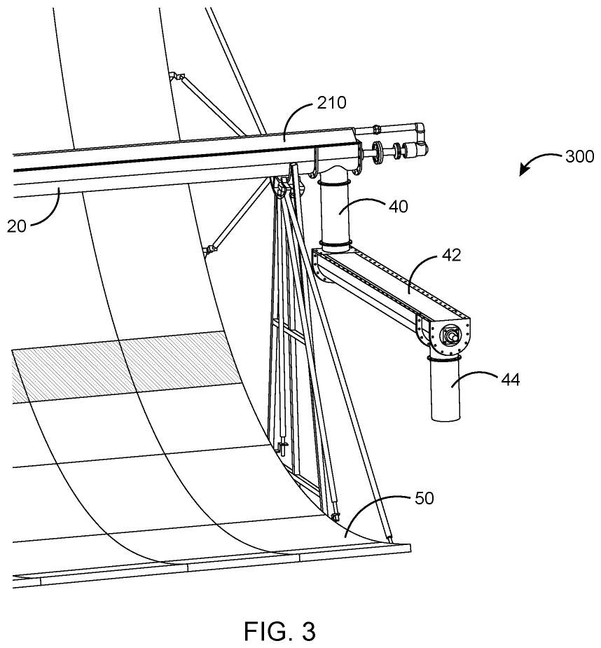

FIG. 3, shown generally as 300 illustrates in more detail how the solids with volatiles removed exit the elongated tube 20 down waste drop 40. These solids enter a long auger discharge 42 where they are conveyed by an internal screw conveyor (auger) system before finally exiting the system as solids through waste drop 44. As discussed earlier in FIG. 2 a vacuum (not shown) is applied at the first end of the elongated tube to give the vapor a flow direction and to lower the boiling point of the liquid. Proper control of that vacuum requires that the two “openings” in the system (the slurry fill 30 and the waste drop 44) are not truly open during operation. As described in FIG. 2 with respect to slurry fill 30 maintenance of the vacuum is aided by controlling the level of slurry in the slurry fill system as the system runs to maintain a seal of solid-liquid slurry within the slurry fill system. With the final waste drop 44 the vacuum seal is maintained by keeping the long auger discharge 42 always filled with solids by a controller that controls the auger speed.

FIG. 4, shown generally as 400 illustrates this further by showing that the long auger discharge 42 has an internal screw conveyor (auger) illustrated by showing part of the wall of the long auger discharge 42 with a transparent wall 41 exhibiting the internal auger within long auger discharge 42. The speed of the auger system can be mechanically chain driven by a sprocket wheel 43 and the speed of that augur is controlled to maintain a full long auger discharge 42, thus maintaining the vacuum.

The use of parabolic solar troughs has obvious advantages related to energy savings. It should be noted though that there are applications in which 24-hour power is needed and the concepts exemplified here could use other sources such as gas or electric heaters to heat the elongated tube when solar impingement is not available. The system described would work in the same way in providing efficient removal of liquids from solid-liquid slurries.

This disclosure has been described with reference to specific details of particular embodiments. It is not intended that such detailed be regarded as limitations upon the scope of the invention except insofar as and to the extent that they are included in the eventual claims.

What we claim is:

1. A solar powered device for efficient removal of volatile liquids from industrial solid-liquid slurries comprising:
a. a screw conveyor inside an elongated tube, with the conveying flights of the screw conveyor mounted onto a hollow pipe within the elongated tube;
b. a first end of the elongated tube comprising a feed port for a solid-liquid slurry;
c. a second end of the elongated tube comprising a waste drop for removal of the solids material after its liquids have been removed;
d. wherein the elongated tube is centered in a parabolic solar trough that impinges solar energy onto the elongated tube to volatilize the volatile liquid from the contained slurry;
e. wherein the elongated tube is not perfectly round but is topped with an enclosed vertical U-shaped or V-shaped top that provides a pathway for the volatile vapor removed from the solid-liquid slurry;
f. wherein a hollow pipe recycles the volatile vapor removed from the solid-liquid slurry counter-currently back through the hollow pipe within the elongated tube to remove the resulting liquid.

2. The solar powered device for efficient removal of volatile liquids from industrial solid-liquid slurries of claim 1 wherein the waste drop for removal of the solids material after its liquids have been removed in the elongated tube further comprises a long auger discharge where they are conveyed by an internal screw conveyor (auger) system before finally exiting the device as solids through a final waste drop.

3. The solar powered device for efficient removal of volatile liquids from industrial solid-liquid slurries of claim 1 wherein a vacuum is applied at the first end of the device to give the volatile vapor a flow direction and to lower the boiling point of the liquid.

4. The solar powered device for efficient removal of volatile liquids from industrial solid-liquid slurries of claim 3 wherein a controller that controls the level of slurry in the slurry fill feed port aids in maintaining the vacuum in the device.

5. The solar powered device for efficient removal of volatile liquids from industrial solid-liquid slurries of claim 2 wherein a controller maintains a vacuum seal in the device by control of the speed of the long auger discharge to keep the long auger filled with solids.

6. The solar powered device for efficient removal of volatile liquids from industrial solid-liquid slurries of claim 1 wherein in a particular application there could be one such elongated tube and for larger applications there could be multiple of these tubes aligned within multiple solar troughs.

7. The solar powered device for efficient removal of volatile liquids from industrial solid-liquid slurries of claim 1 further comprising the addition of electric or gas heaters to heat the elongated tube to achieve 24-hour power in the absence of solar impingement.

8. A method for utilizing solar power for efficient removal of volatile materials such as water from industrial slurries comprising:
a. providing a screw conveyor inside an elongated tube, with the conveying flights of the screw conveyor mounted onto a hollow pipe within the elongated tube;
b. providing a first end of the elongated tube with a feed port for a solid-liquid slurry;
c. providing a second end of the elongated tube with a waste drop for removal of solids material;
d. positioning the elongated tube in a parabolic solar trough that impinges solar energy onto the elongated tube to volatilize the volatile liquid from the contained slurry;
e. providing an enclosed vertical U shaped or V-shaped top to the elongated tube that provides a pathway for the volatile vapor removed from the solid-liquid slurry;
f. providing a vacuum at the first end of the elongated tube to pull the flow of volatized vapor from the second end of the elongated tube in a counter-current flow in the hollow pipe of the elongated tube;
g. providing an exit from the hollow pipe of the elongated tube for removing the liquid of the solid-liquid slurry.

9. The method for utilizing solar power for efficient removal of volatile materials such as water from industrial slurries of claim 8 further providing a long auger discharge where they are conveyed by an internal screw conveyor (auger) system before finally exiting the system as solids through a waste drop.

10. The method for utilizing solar power for efficient removal of volatile materials such as water from industrial slurries of claim 8 further providing a vacuum is applied at the first end of the device to give the volatile vapor a flow direction and to lower the boiling point of the liquid.

11. The method for utilizing solar power for efficient removal of volatile materials such as water from industrial slurries of claim 10 further providing a controller that controls the level of slurry in the slurry fill feed port that aids in maintaining the vacuum in the device.

12. The method for utilizing solar power for efficient removal of volatile materials such as water from industrial slurries of claim 10 further providing a controller that maintains a vacuum seal in the device by control of the speed of the long auger discharge to keep the long auger filled with solids.

13. The method for utilizing solar power for efficient removal of volatile materials such as water from industrial slurries of claim 8 providing for some larger applications multiple of these elongated tubes aligned within multiple solar troughs.

14. The method for utilizing solar power for efficient removal of volatile materials such as water from industrial slurries of claim 8 further providing the addition of electric or gas heaters to heat the elongated tube to achieve 24-hour power in the absence of solar impingement.

15. The method for utilizing solar power for efficient removal of volatile materials such as water from industrial slurries of claim 8 further providing for control of the screw conveyor speed within the elongated tube to provide control of the degree of dryness of the solids achieved.
